(19) United States
(12) Patent Application Publication
(10) Pub. No.: US 2012/0266444 A1
(43) Pub. Date: Oct. 25, 2012

(54) Button-Mounting Process, Button-Mounting System, and Button-Mounting Upper Die

(75) Inventors: Kenji Hasegawa, Chiyoda-Ku (JP); Makoto Momose, Chiyoda-Ku (JP)

(73) Assignee: YKK Corporation, Tokyo (JP)

(21) Appl. No.: 13/497,390

(22) PCT Filed: Oct. 22, 2009
(86) PCT No.: PCT/JP2009/068196

§ 371 Date: Jul. 1, 2012

(51) Int. Cl. B23P 11/00

(52) U.S. Cl. 29/432.1; 29/243.5

(57) ABSTRACT

An upper die with a button-mounting member includes a solid axial part with a flat tip, a bar-like pin member with a pointed tip, and a cylindrical punch surrounding the pin member. The button is set above the cloth and the button-mounting member is disposed below the cloth. The upper die is lowered until the button comes into contact with the upper side of the cloth and the tip of the axial part contacts the lower side of the cloth. The pin member is lowered until the tip hits against the tip of the axial part, resulting in a pilot bore through the cloth. The axial part passes through the cloth along the pilot bore and through the mounting opening. After that, the axial part is swaged by the pin member and the punch.

The invention relates to a button-mounting process, a button-mounting system, and a button-mounting upper die for mounting a button such as a female snap and a male snap onto a cloth.

When a button such as a female snap and a male snap is about to be mounted to a cloth, generally, the button is disposed above the cloth oriented horizontally and a button-mounting member is disposed below the cloth. Then, an axial part of the button-mounting member is swaged by an upper die after the axial part has pierced the cloth and then passed through a button-mounting opening of the button. However, there would occur a poor swaging because, when the axial part of the button-mounting member is piercing the cloth, threads forming the cloth can be entrained upward by the tip of the axial part and be involved in a deformation of the axial part as swaged.

As a technique to deal with a poor piercing in a cloth as mentioned above, Japanese Examined Patent Application Publication No. 52-2335 discloses that a pin member with a sharp tip first penetrates a cloth from the lower side, and then an axial part of the button-mounting member passes through the cloth. In this technique, however, the axial part of the button-mounting member must be hollow and tubular, and therefore the technique cannot be applied to a commonly-used button-mounting member with a solid axial part. Especially, when a cloth is thick, there would be a shortage of a portion of the axial par for swaging.

Further, the axial part of the button-mounting member does not taper off to a tip, and therefore when a button is tried to be mounted to a firm cloth such as a fiber cloth with a resin layer (waterproof coating) on at least one side thereof, the axial would be deformed without smoothly passing through the cloth even after the pin member has run through the cloth.

[Patent document 1] Japanese Examined Patent Application Publication No. 52-2335

The invention has been made in view of the above-mentioned problems, and an object of the invention to provide a button-mounting process, a button-mounting system, and a button-mounting upper die, which are suitable for a thick or firm cloth, and in which an axial part of a button-mounting member would not entrain threads forming a cloth at the time of piercing the cloth and a button-mounting member with a solid axial part can be used.

### SUMMARY OF THE INVENTION

To solve the problems, according to an invention, there is provided a process for mounting a button having a mounting opening onto a cloth using a button-mounting member and an upper die, the button-mounting member including a tapered solid axial part with a flat tip, the upper die including a bar-like pin member with a pointed tip and a cylindrical punch surrounding the pin member, the process comprising the steps of: (A) after setting the button above the cloth oriented horizontally and the button-mounting member lower the cloth, respectively, lowering the upper die until the button comes into contact with the upper side of the cloth and the tip of the axial part of the button-mounting member contacts the lower side of the cloth; (B) while keeping the tip of the axial part of the button-mounting member in contact with the lower side of the cloth, lowering only the pin member until the tip hits against the tip of the axial part to form a pilot bore through the cloth; (C) passing the axial part of the button-mounting member through the cloth along the pilot bore, and then through the mounting opening; and (D) swaging the axial part, which has passed through the cloth and the mounting opening, by the pin member and the punch.

In the invention, as specific examples of a button to be mounted, a female snap and a male snap, which constitutes a snap button, are given.

In the button-mounting process according to the invention, from the state where the button is in contact with the upper side of the cloth and the tip of the axial part of the button-mounting member is in contact with the lower side of the cloth, the pin member moves downward until the tip of the pin member, after passing through the mounting opening of the button, hits against the tip of the axial part, which forms the pilot bore through the cloth. At this time, since the tip of the pin member is pointed and the cloth is supported from the downside by the flat tip of the axial part of the button-mounting member, the pin member can pierce the cloth without entraining threads forming the cloth while the tip of the pin member goes into between warp and weft threads, shoving them aside and expanding a space between threads. Such a cloth-piercing quality of the pin member may be enhanced by making the pin member higher in hardness than the axial part of the button-mounting member. Further, since the tapered axial part of the button-mounting member can pass through the cloth along the pilot bore, the axial part would barely take along threads, and if the cloth is firm, it will be possible to pass the axial part through the cloth smoothly.

In an embodiment of the button-mounting process according to the invention, the motion, in the step (C), of passing the axial part of the button-mounting member through the cloth along the pilot bore is performed while the tip of the axial part is kept in contact with the tip of the pin member which leaves the pilot bore for the first time. In this case, it would be almost unnecessary for the axial part itself of the button-mounting member to expand the pilot bore as passing through it, which may further lower a possibility of the axial part taking along threads and enhance the quality of the axial part in piercing the cloth.

In an embodiment of the button-mounting process according to the invention, the step (D) includes deforming the axial part by the pin member, and subsequently deforming further the axial part by the punch. In this case, the axial part of the button-mounting member is deformed to be expanded radially outward and then the axial part including deformed portion is crushed by the punch.

According to another invention, there is provided a system for mounting a button onto a cloth, comprising: a button-mounting member including a disk-like base and a tapered solid axial part which extends from an center area of the base, a tip of the solid axial part being flat; and an upper die including a bar-like pin member with a pointed tip, a cylindrical punch surrounding the pin member, and a button-holding portion to hold the button at the time of mounting the button to the cloth, the pin member and the punch being used for swaging the axial part of the button-mounting member, wherein, from the state where the button is in contact with the upper side of the cloth and the tip of the axial part of the button-mounting member is in contact with the lower side of the cloth, the pin member is lowered until the tip of the pin member, after passing through a mounting opening of the button, hits against the tip of the axial part, resulting in a pilot bore through the cloth. This button-mounting system can be used in performing the button-mounting process.

In the invention, as materials for the pin member and the punch, steel and the like can be cited. As material for the button-mounting member including the axial part, resin, specifically polyamide (PA), polyacetal (POM), polycarbonate (PC), modified polyphenylene ether (m-PPE), polybutylene terephthalate (PBT), polyethylene terephthalate (PET), glass-reinforced polyethylene terephthalate (GF-PET), cyclic polyolefin (COP), etc. can be cited. The button-mounting member may be made of metal such brass and aluminum alloy.

In an embodiment of the button-mounting system according to the invention, the pin member is higher in hardness than the axial part of the button-mounting member. For instance, by lowering the pin member made of steel from above the cloth toward the axial part of the button mounting member made of resin supporting the cloth from the downside, the pin member can surely pierce the cloth as forming a pilot bore.

The button-mounting system according to the invention can further comprise a lower die for supporting the button-mounting member. In this system, the upper die and/or the lower die can be moved up and down.

According to still another invention, there is provided an upper die for mounting a button having a mounting opening onto a cloth using a button-mounting member including a tapered solid axial part with a flat tip, comprising: a bar-like pin member with a pointed tip, a cylindrical punch surrounding the pin member, and a button-holding portion to hold the button at the time of mounting the button to the cloth, the pin member and the punch being used for swaging the axial part of the button-mounting member, wherein, from the state where the button is in contact with the upper side of the cloth and the tip of the axial part of the button-mounting member is in contact with the lower side of the cloth, the pin member is lowered until the tip of the pin member, after passing through a mounting opening of the button, hits against the tip of the axial part, resulting in a pilot bore through the cloth. This button-mounting upper die can be used in performing the button-mounting process.

In an embodiment of the button-mounting upper die according to the invention, the pin member is higher in hardness than the axial part of the button-mounting member.

In the invention, from the state where the button is in contact with the upper side of the cloth and the flat tip of the solid axial part of the button-mounting member is in contact with the lower side of the cloth, the pin member moves downward until the tip of the pin member hits against the tip of the axial part after passing through the mounting opening of the button. As a result, the pilot bore can be formed through the cloth without the tip of the pin member entraining threads forming the cloth. In addition, the tapered axial part of the button-mounting member can be passed through the cloth along the pilot bore. Therefore, the axial part would not take along threads forming the cloth as passing through the cloth. Further, since the button-mounting member with the solid axial part is used, there is unlikely to be short of a portion of the axial part for swaging. Furthermore, even if the cloth is firm, the axial part can be passed through the cloth smoothly.

### BRIEF DESCRIPTION OF THE DRAWINGS

FIG. 1 is an illustrative sectional view showing an upper die, a female snap (a button), a cloth, a button-mounting member, and a lower die as arranged in the up-and-down direction before the female snap is mounted to the cloth.

FIG. 2 is a perspective view of the button-mounting member.

FIG. 3 is an illustrative sectional view showing a state where the bottom is in contact with the upper side of the cloth and the tip of the axial part of the button-mounting member is in contact with the upper side of the cloth.

FIG. 4 is an illustrative sectional view showing a state where the pin member, which has been lowered from the FIG. 3 state, hits against the tip of the axial part of the button-mounting member.

FIG. 5 is an enlarged illustrative view of the tip of the pin member in the FIG. 4 state, which has pierced the cloth.

FIG. 6 is an illustrative sectional view showing a state where the axial part of the button-mounting member has passed through the cloth and then the button-mounting opening of the button.

FIG. 7 is an enlarged illustrative view showing a state where the axial part of the button-mounting member is swaged by the pin member.

FIG. 8 is an enlarged illustrative view showing a state where the axial part of the button-mounting member is swaged by a punch.

FIG. 9 is an illustrative sectional view showing an arrangement similar to FIG. 1 as an example of using a male snap as a button.

FIG. 10 is an enlarged illustrative view showing a state where the axial part of the button-mounting member is swaged in the FIG. 9 example.

### DETAILED DESCRIPTION OF THE INVENTION

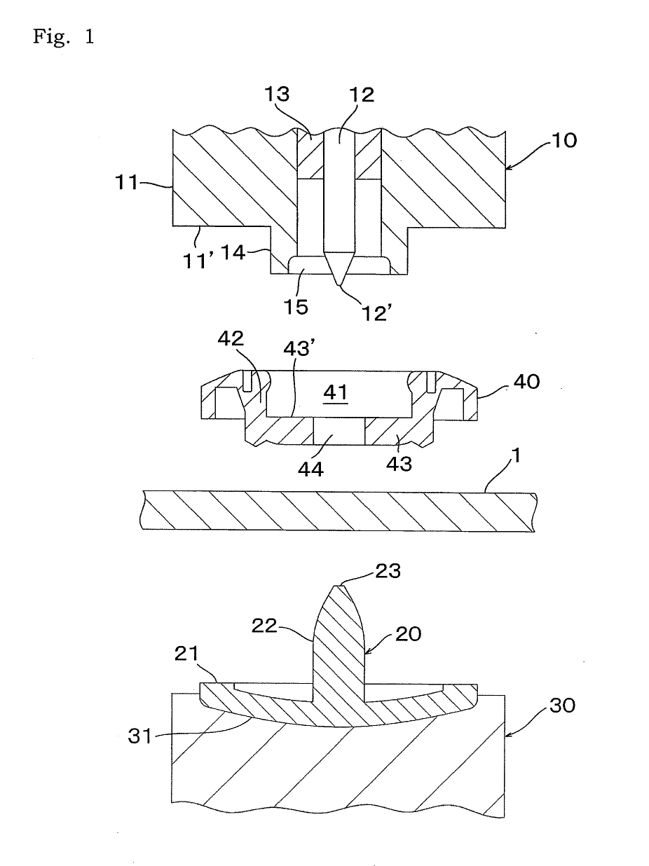

Hereinafter, preferred embodiments of the invention will be described with reference to the drawings. FIG. 1 is an illustrative sectional view showing a button-mounting upper die (hereinafter referred to merely as “upper die”) 10, a button-mounting member 20, a lower die 30, a cloth 1, and a female snap 40 as an example of a button arranged in the up-and-down direction (the axial direction). The upper die 10, the button-mounting member 20 and the lower die 30 constitute a button-mounting system according to an embodiment of the invention. In the Fig., in the top-down-order, there are arranged the upper die 10, the female snap 40, the cloth 1, the button-mounting member 20, and the lower die 30. An upper part of the upper die 10 is coupled to an upper-die drive of a press machine though omitted in the drawings, while only a lower part of the upper die 10 is shown in FIG. 1 etc. The upper die 10 (its lower part) comprises a thick-walled cylindrical housing 11, a bar-like steel pin member 12 which is placed in an inner space of the housing 11 along its axis, and a cylindrical steel punch 13 which is received in the inner space of the housing 11 and surrounds the pin member 12. The pin member 12 and the punch 13 is moved up and down separately with respect to the housing 11 by the upper-die drive of the press machine. The pin member 12 includes a conically tapering tip portion having a pointed tip 12′. The bottom of the punch 13 is an annular flat surface. The housing 11 includes a cylindrical button-holding portion 14 which extends downward from the bottom 11′ of the housing.

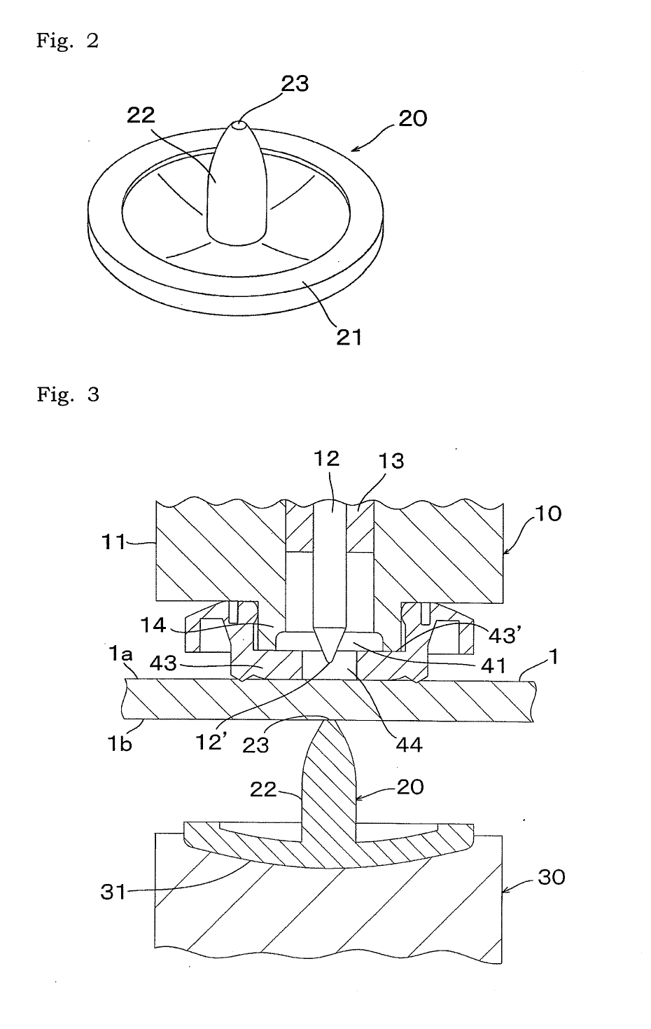

The button-mounting member 20 is made of acetal resin. As shown in a perspective view of FIG. 2, the member 20 includes an almost disk-like base 21 and a solid axial part 22 which extends from an center area of the base 21. The axial part 22 tapers off to a tip 23 formed as a small round flat face. The lower die 30 is arranged always concentrically with the upper die 10. In the embodiment, the upper die 10 moves up and down, while the lower die 30 remains stationary. The lower die 30 has, on the tip, a concave mounting-member support portion 31 which receives the base 21 of the button-mounting member 20 conformably. The button-mounting member 20 as set on the support portion 31 is concentric with the upper die 10 (and its pin member 12).

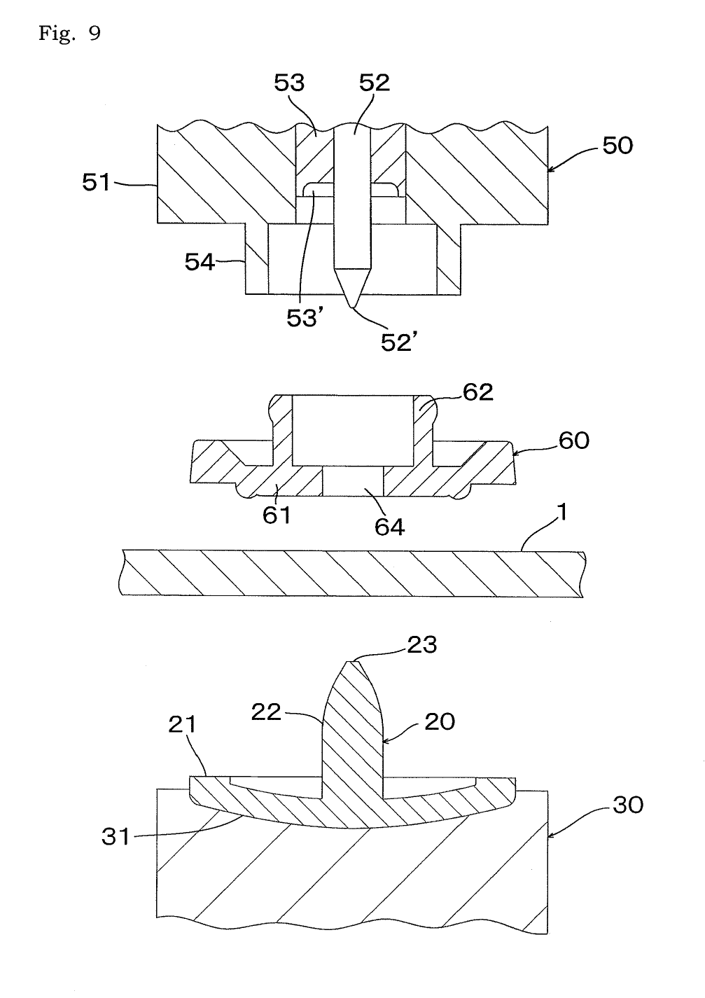

The female snap 40, which is well-known product, includes a circular side 42 and a disk-like bottom 43 defining an engagement depression 41 to detachably receive an engagement projection 62 of a male snap 60 (see FIG. 9). In a center of the bottom 43, there is formed a mounting opening (hereinafter referred to merely as “opening”) 44. The outer diameter of the button-holding portion 14 is designed to be slightly less than the diameter of the engagement depression 41 of the female snap 40. The height of the button-holding portion 14 projecting from the bottom 11′ of the housing 11 is designed to be equal or slightly more than the depth of the engagement depression 41. Further, the inner diameter of the button-holding portion 14 except its inner lower end is equal to the inner diameter of the housing 11. The inner lower end is formed as a diameter-enlarged portion 15 in which the inner diameter is enlarged so as to accommodate a swaged and deformed axial part of the button-mounting member 20 as described later. Such a diameter-enlarged portion 15 is not always necessary.

Next, as an embodiment of the button-mounting process according to the invention, there will be described a procedure to mount the female snap 40 onto the cloth 1 using the button-mounting system. First, the button-mounting member 20 is set on the mounting-member support portion 31 of the lower die 30, and then the upper die 10 is lowered to the female snap 40 above the cloth 1. The upper die 10 moving downward is stopped when the bottom 43 of the female snap 40 comes into contact with the upper side 1a of the cloth 1 and the tip 23 of the axial part 22 of the button-mounting member 20 comes into contact with the lower side 1b of the cloth 1, respectively, as shown in FIG. 3. At this time, the button-holding portion 14 of the upper die 10 comes into the engagement depression 41 of the female snap 40, and the lower end 14′ of the portion 14 contacts the upper surface 43′ of the bottom 43 of the female snap 40. And the cloth 1 is held between the bottom 43 of the female snap 40 and the tip 23 of the axial part 22 of the button-mounting member 20 with a relatively weak force.

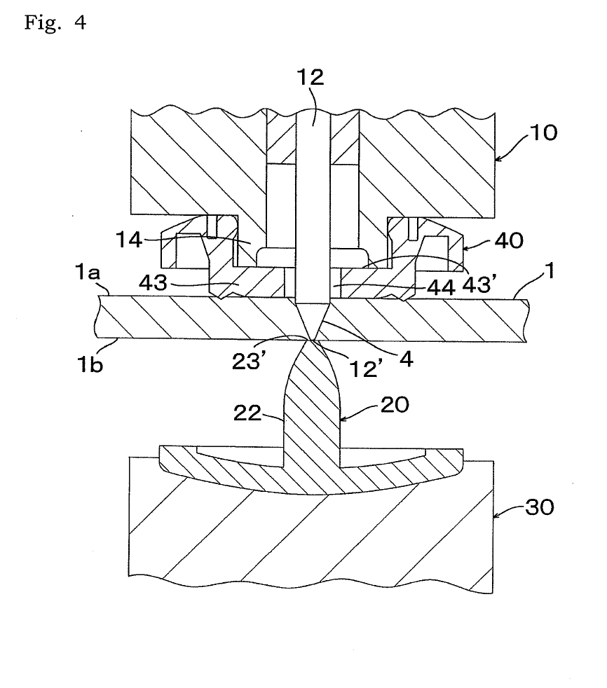

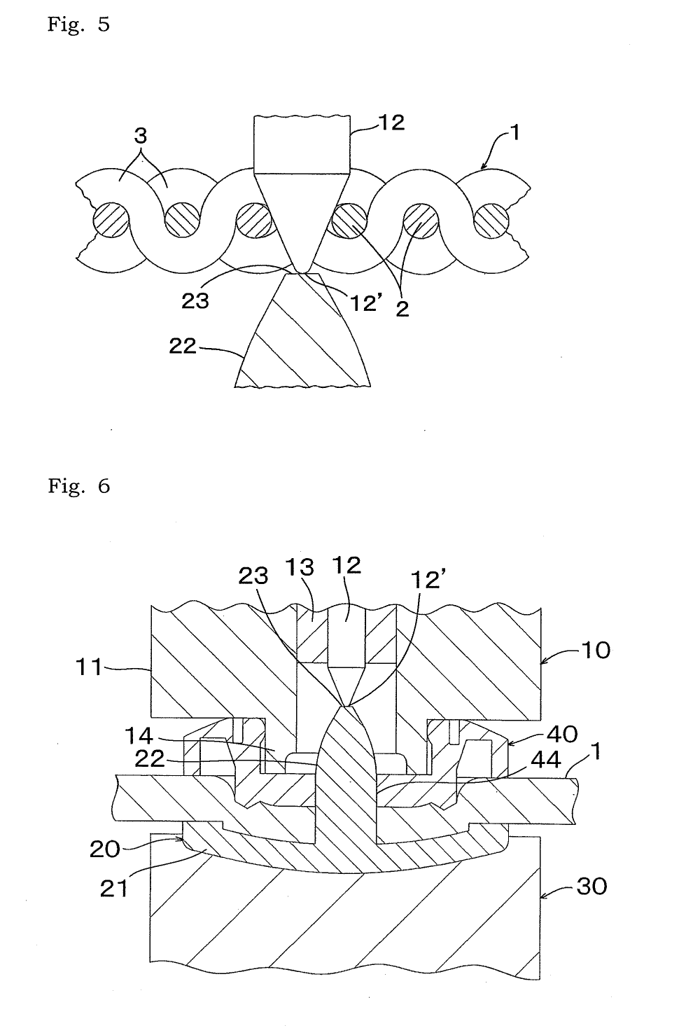

From the state of FIG. 3, only the pin member 12 in the upper die 10 is lowered till the tip 12′ hits against the tip 23 of the axial part 22 of the button-mounting member 20 as shown in FIG. 4. At this time, the tip 12′ of the pin member 12 can pierce the cloth 1 and then contact the tip 23 of the axial part 22. This is because the pin member 12, whose tip 12′ is pointed, is made of steel and so it is higher in hardness than the axial part 22 of the button-mounting member 20 as made of resin, and the cloth 1 is supported from the downside by the flat tip 23 of the axial part 22 of the button-mounting member 20. Thereby, in the cloth 1, a pilot bore 4 is formed. In addition, when the pointed tip 12′ of the pin member 12 is piercing the cloth 1, as shown and enlarged in FIG. 5, it can advance while going into between warp and weft threads 2, 3 which form the cloth 1 and shoving aside the threads. Therefore, the pin member 12 would not entrain threads 2, 3.

Next, from the state of FIG. 4, while the pin member 12 is kept stationary at the position in contact with the tip 23 of the axial part 22 of the button-mounting member 20, the upper die 10 except the pin member 12 is lowered again. Thereby, the female snap 40 pushes down the cloth 1, and accordingly the axial part 22 of the button-mounting member 20 passes through the cloth 1 upward, as shown in FIG. 6, and then going through the opening 44 of the female snap 40 into the inside of the button-holding portion 14 of the upper die 10. When the axial part 22 of the button-mounting member 20 is passing through the cloth 1, the axial part 22 would not entrain threads 2, 3 upward for the following reasons: i) The tapered axial part 22 can go through the cloth 1 along the above-mentioned pilot bore 4. ii) The tapered axial part 22 of the button-mounting member 20 enters the pilot bore 4 as the pin member 12, which has formed the pilot bore 4, leaves the bore for the first time, the axial part 22 relatively moves upward along the bore 4 as the pin member 12 relatively goes up, where the axial part 22 itself would barely expands the pilot bore 4. Further, if the cloth 1 is firm, it will be possible to pass the axial part 22 through the cloth 1 smoothly. In the state of FIG. 6, the cloth 1 is held between the base 21 of the button-mounting member 20 and the bottom 43 of the female snap 40 with a force stronger than in the FIG. 3 state.

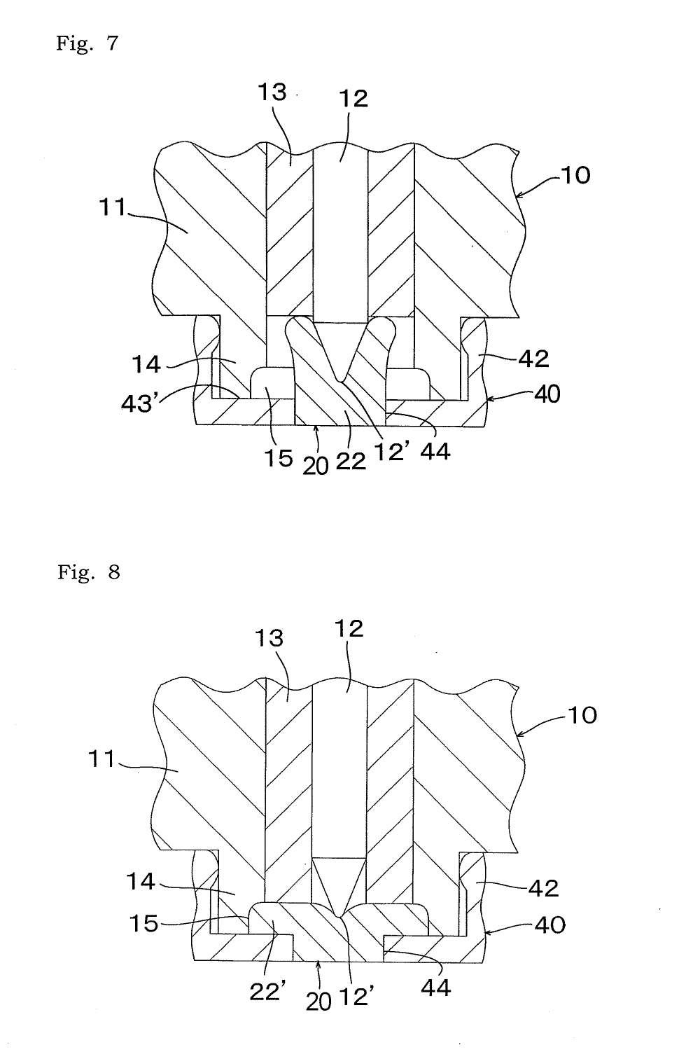

Next, from the state of FIG. 6, the pin member 12 is lowered, as shown in FIG. 7, the pin member 12, from the tip 12′, breaks into the axial part 22, from the tip 23 shoving an upper portion of the axial part 22 radially outward. Then, by moving down the punch 13, as shown in FIG. 8, the punch 13 crushes flatly the axial part 22 including the radially-outward shoved portion by the pin member 12 against the upper surface 43′ of the bottom 43 of the female snap 40. The crushed axial part 22′ is received within the diameter-enlarged portion 15 of the button-holding portion 14 of the upper die 10. In this way, the axial part 22 is swaged and the female snap 40 is fixed onto the cloth 1.

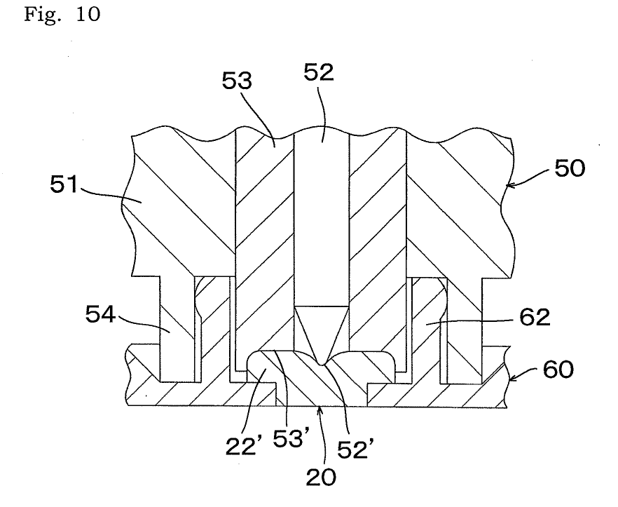

FIG. 9 is an illustrative sectional view, similar to FIG. 1, showing a button-mounting system according to another embodiment of the invention. In the embodiment, a male snap 60 as another example of a button is the subject to be mounted. Further, since the constructions other than making a modification to a part of an upper die 50 to conform to the configuration of the male snap 60 are substantially the same as those in FIG. 1, as for the cloth 1, the button-mounting member 20 and the lower die 30, the same reference numerals as in FIG. 1 are used, and explanations for them are omitted. The male snap 60, which is well-known product, includes a disk-like bottom 61 and a cylindrical engagement projection 62 projecting from the bottom 61. The engagement projection 62 can detachably engage the engagement depression 41 of the female snap 40. In a center of the bottom 61 radially inward rather than the engagement projection 62, there is formed a mounting opening 64. The upper die 50 includes a housing 51, a pin member 52 and a punch 53. The housing 51 has a button-holding portion 54 which extends downward from the bottom of the housing 51. Major differences of the upper die 50 from the upper die 10 are as follows. One is that the inner diameter of the button-holding portion 54 is designed to be slightly more than the diameter of the engagement projection 62 of the male snap 60. Another one is that a diameter-enlarged portion 53′ is formed in the lower end of the punch 53 so as to receive a swaged and deformed portion of the axial part 22 of the button-mounting member 20. Such a diameter-enlarged portion 53′ is not always necessary. Although the operation of mounting the male snap 60 to the cloth 1 is the same as described above, with the two differences, as shown in FIG. 10, when the axial part 22 of the button-mounting member 20 is being swaged, the engagement projection 62 of the male snap 60 is received inside the button-holding portion 54, and the axial part 22 is crushed by the diameter-enlarged portion 53′ of the punch 53 being received in the portion 53′.

As described above, in the embodiments of the button-mounting process according to the invention, it will be possible to pass the tapered axial part 22 of the button-mounting member 20 through the cloth 1 along the pilot bore 4, the axial part 22 would not entrain threads forming the cloth 1 when it is passing through the cloth 1. Further, since the button-mounting member 20 with the solid axial part 22 is used, even if the cloth 1 is thick, there is unlikely to be short of a portion of the axial part for swaging. Furthermore, even if the cloth 1 is a firm cloth such as a fiber cloth with a resin layer on at least one side thereof, it will be possible to pass the axial part 22 through the cloth 1 smoothly.

### DESCRIPTION OF REFERENCE NUMBERS

1 cloth
4 pilot bore
10, 50 upper die
11, 51 housing
12, 52 pin member
12′, 52′ tip of the pin member
13, 53 punch
14, 54 button-holding portion
15, 53′ diameter-enlarged portion
20 button-mounting member
22 axial part
22′ deformed axial part
23 tip of the axial part
30 lower die
40 female snap
41 engagement depression
44 mounting opening
60 male snap
62 engagement projection
64 mounting opening

1. A process for mounting a button having a mounting opening onto a cloth using a button-mounting member and an upper die, the button-mounting member including a tapered solid axial part with a flat tip, the upper die including a bar-like pin member with a pointed tip and a cylindrical punch surrounding the pin member, the process comprising the steps of:
(A) after setting the button above the cloth oriented horizontally and the button-mounting member lower the cloth, respectively, lowering the upper die until the button comes into contact with the upper side of the cloth and the tip of the axial part of the button-mounting member contacts the lower side of the cloth;
(B) while keeping the tip of the axial part of the button-mounting member in contact with the lower side of the cloth, lowering only the pin member until the tip hits against the tip of the axial part to form a pilot bore through the cloth;
(C) passing the axial part of the button-mounting member through the cloth along the pilot bore, and then through the mounting opening; and
(D) swaging the axial part, which has passed through the cloth and the mounting opening, by the pin member and the punch.

2. The process according to claim 1, wherein the motion, in the step (C), of passing the axial part of the button-mounting member through the cloth along the pilot bore is performed while the tip of the axial part is kept in contact with the tip of the pin member which leaves the pilot bore for the first time.

3. The process according to claim 1 or 2, wherein the step (D) includes deforming the axial part by the pin member, and subsequently deforming further the axial part by the punch.

4. A system for mounting a button onto a cloth, comprising:
a button-mounting member including a disk-like base and a tapered solid axial part which extends from an center area of the base, a tip of the solid axial part being flat; and
an upper die including a bar-like pin member with a pointed tip, a cylindrical punch surrounding the pin member, and a button-holding portion to hold the button at the time of mounting the button to the cloth, the pin member and the punch being used for swaging the axial part of the button-mounting member,
wherein, from the state where the button is in contact with the upper side of the cloth and the tip of the axial part of the button-mounting member is in contact with the lower side of the cloth, the pin member is lowered until the tip of the pin member, after passing through a mounting opening of the button, hits against the tip of the axial part, resulting in a pilot bore through the cloth.

5. The system according to claim 4, wherein the pin member is higher in hardness than the axial part of the button-mounting member.

6. The system according to claim 4 or 5, further comprising a lower die for supporting the button-mounting member.

7. An upper die for mounting a button having a Mounting opening onto a cloth using a button-mounting member including a tapered solid axial part with a flat tip, comprising:
a bar-like pin member with a pointed tip, a cylindrical punch surrounding the pin member, and a button-holding portion to hold the button at the time of mounting the button to the cloth, the pin member and the punch being used for swaging the axial part of the button-mounting member,
wherein, from the state where the button is in contact with the upper side of the cloth and the tip of the axial part of the button-mounting member is in contact with the lower side of the cloth, the pin member is lowered until the tip of the pin member, after passing through a mounting opening of the button hits against the tip of the axial part, resulting in a pilot bore through the cloth.

8. The upper die according to claim 7, wherein the pin member is higher in hardness than the axial part of the button-mounting member.
